(19) United States
(12) Patent Application Publication
(10) Pub. No.: US 2014/0132846 A1
(43) Pub. Date: May 15, 2014

(54) SCREEN DEVICE AND PROJECTION APPARATUS HAVING A SCREEN DEVICE

(71) Applicant: SAMSUNG ELECTRONICS CO., LTD., Suwon-si (KR)

(72) Inventors: Jun-seok PARK, Suwon-si (KR); Go-hyun KIM, Yongin-si (KR); Hak-young KIM, Yongin-si (KR); Jean HUR, Seongnam-si (KR)

(21) Appl. No.: 13/927,837

(22) Filed: Jun. 26, 2013

(30) Foreign Application Priority Data
Nov. 14, 2012 (KR) 10-2012-0128884

(51) Int. Cl. H04N 5/74

(52) U.S. Cl. CPC H04N 5/7475
USPC 348/789

(57) ABSTRACT

A screen device and a projection apparatus having the same are provided. The screen device includes a screen on which an image is projected, and a support panel which includes a pair of plates and a strength reinforcement member arranged between the pair of plates, wherein the screen is attached to any one of the pair of plates.

### PRIORITY

This application claims priority under 35 U.S.C. §119(a) to Korean Patent Application No. 10-2012-0128884, filed on Nov. 14, 2012, in the Korean Intellectual Property Office, the disclosure of which is incorporated herein by reference, in its entirety.

### BACKGROUND

1. Field

The exemplary embodiments of the disclosure relate to a screen device and a projection apparatus having a screen device. More particularly, the exemplary embodiments relate to a projection apparatus which projects an image through a screen device.

2. Description of the Related Art

In general, a projection apparatus is separately provided with an image projector which projects an image, and a screen on which the projected image is displayed. In the case where the image projector and the screen are separately provided, the screen is fixed to a picture frame, hangs on a wall, or is fixed to separate furniture, and the image projector is arranged in a separate device in front of the screen.

In the above-described projection apparatus in the related art, upper, lower, right, and left end portions of the screen are elastically fixed to an inside of a bezel so that the screen can retain its flatness. For this, a structure is adopted in which one side of each of a plurality of coil springs is installed along the upper, lower, right, and left end portions of the screen, and the other side of each of the plurality of coil springs is fixed to the bezel.

However, according to the structure in the related art which performs planarization of the screen using elastic forces of the plurality of coil springs, the elastic forces of the respective coil springs deteriorate over a period of time, and thus it becomes difficult to maintain the flatness of the screen.

Further, since it is necessary to produce the bezel with a thickness that satisfies a predetermined strength, so that the shape of the bezel is not deformed due to tension applied from the plurality of coil springs connected to the bezel, the size of the bezel is increased. However, this causes the weight of the screen device to be increased. Due to such problems, the size of the bezel is unable to be reduced. This creates an obstacle to providing a slim screen device.

In addition, in a large-screen projection device, screen distortion occurs depending on the degree of alignment between the screen and the image projector. That is, if the projection angle of an optical system of the image projector differs or the minor angle is distorted, an optical path is changed which causes the occurrence of a keystone phenomenon, where the displayed image takes on a keystone shape.

Further, if the distance between the screen and the image projector is not accurately set, an image that is displayed on the screen will not be focused, resulting in a blurry image.

The large-screen projection apparatus in the related art suffers from the problems that a separate adjustment structure for solving the above-described keystone phenomenon and for setting the focus is not provided, and even if such an adjustment structure is provided, its structure is complicated.

### SUMMARY

The present disclosure has been made to address at least the above problems and/or disadvantages and to provide at least the advantages described below. Accordingly, an aspect of the exemplary embodiments provides a screen device which can be lightweight through miniaturization of the size of a bezel, while maintaining planarization of a screen.

Another aspect of the exemplary embodiments provides a screen device which can stereoscopically display an image through the forming of a curved screen device.

Still another aspect of the exemplary embodiments provides a projection apparatus having a supporting device which solves the problem of the keystone phenomenon, facilitates focus setting, and contains a simple structure.

According to one aspect of an exemplary embodiment, a screen device includes a screen on which an image is projected; and a support panel which includes a pair of plates and a strength reinforcement member arranged between the pair of plates, wherein the screen is attached to any one of the pair of plates.

The screen may be laminated on any one of the pair of plates.

The reinforcement member may have any one of a honeycomb structure, a wave shape, and a structure in which a plurality of grooves are successively formed in upper, lower, right, and left directions at predetermined distances.

A side of the support panel, to which the screen is attached, may be concavely formed.

The screen device further may comprise a plurality of support panels, wherein all of the support panels are successively connected to one another, and the screen is attached to one surface of all of the support panels.

According to another aspect of an exemplary embodiment, a projection apparatus includes a screen device having a screen and a support panel unit to which the screen is coupled; a supporting device which supports the screen device; a base frame on which the supporting device is supported; and an image projector which projects an image onto the screen.

The support panel may include a pair of plates; and a strength reinforcement member may be arranged between the pair of plates, wherein the screen is attached to any one of the pair of plates.

The supporting device may be connected to the screen device so that the supporting device supports the screen device and adjusts a slope of the screen device.

The supporting device may include a screen holder coupled to the support panel of the screen device; a coupling plate which is elastically connected to the screen holder so that the screen holder is movable; a guide bracket coupled to the coupling plate in order to support the screen holder and to guide a right-left height and a right-left center of the screen device; and a main bracket fixed to the base frame and connected to both the guide bracket and the coupling plate.

The screen holder and the support panel may be fixedly coupled to each other through an adhesive or through a fastening member, but is not limited thereto.

A plurality of elastic members may be arranged between the screen holder and the coupling plate.

The plurality of elastic members may be supported by first to third fastening protrusions which project from the screen holder, and the first and second fastening protrusions may be arranged at a predetermined distance from each other at the same height, and the third fastening protrusion may be arranged at a height that is different from the height of the first and second fastening protrusions.

The third fastening protrusion may be arranged in a position which is lower than the first and second fastening protrusions and has the same distance with the first and second fastening protrusions.

The first to third fastening protrusions may be screw-engaged with first to third adjustment members which penetrate the coupling plate, and the first to third adjustment members may adjust a distance between the coupling plate and the screen holder.

The screen holder and the coupling plate may be elastically supported at first to third points, and the first and second points may be positioned at a predetermined distance at the same height, and the third point may be arranged at a position which is lower than the first and second points, and which has the same distance with the first and second points.

First to third adjustment members, which fasten the screen holder and the coupling plate to each other, may be positioned at the first to third points, and the first to third adjustment members may adjust a distance between the coupling plate and the screen holder in accordance with a degree of fastening between the screen holder and the coupling plate.

The guide bracket may be provided with a first guide and a second guide which are symmetrically formed with each other, the screen holder may include a first guide protrusion and a second guide protrusion formed on a rear surface thereof to be guided by the first guide and the second guide, and the first guide may have a first guide surface and a second guide surface arranged at right angles to the first guide surface, and the second guide may have a third guide surface that is positioned on the same straight line as the first guide surface and may have a fourth guide surface which is arranged at right angles to the third guide surface, and the first guide protrusion may be guided on the first guide surface and the second guide surface of the first guide, and the second guide protrusion may be guided on the third guide surface and the fourth guide surface of the second guide.

An exemplary embodiment may further provide a projection apparatus including:

a screen device having a screen and a support panel to which the screen is coupled; a supporting device which supports the screen device; and an image projector which projects an image onto the screen, wherein the supporting device adjusts for a keystone effect. The supporting device is connected to the screen device and adjusts a slope of the screen device.

The support panel may include: a pair of plates; and a strength reinforcement member arranged between the pair of plates, wherein the screen is attached to either one of the plates.

### BRIEF DESCRIPTION OF THE DRAWINGS

The above and other aspects, features and advantages of the exemplary embodiments will be more apparent from the following detailed description when taken in conjunction with the accompanying drawings, in which:

FIG. 1 is a schematic cross-sectional view which illustrates a projection apparatus according to an exemplary embodiment;

FIG. 2 is a perspective of the projection apparatus of FIG. 1 with a housing and a cover frame omitted;

FIG. 3 is a perspective view which illustrates a screen device of FIG. 2 where the bezel has been omitted;

FIG. 4 is a schematic exploded perspective view which illustrates a support panel illustrated in FIG. 3;

FIG. 5 is a perspective view which illustrates another example of a strength reinforcement member illustrated in FIG. 4;

FIG. 6 is a perspective view which illustrates still another example of a strength reinforcement member illustrated in FIG. 4;

FIG. 7 is a partially enlarged perspective view which illustrates a rear surface of the screen device illustrated in FIG. 1;

FIG. 8 is a perspective view which illustrates an example of a curved screen device illustrated in FIG. 2.

FIG. 9 is an exploded perspective view which illustrates a supporting device of a projection apparatus according to an exemplary embodiment;

FIG. 10 is a perspective view which illustrates a front surface of the screen holder illustrated in FIG. 9;

FIG. 11 is a schematic view which illustrates the supporting device of FIG. 9 that is mounted on a rear surface of the screen device;

FIG. 12 is a schematic view which illustrates a right-left keystone adjustment state of the screen device illustrated in FIG. 9; and

FIG. 13 is a schematic view which illustrates an upper-lower keystone adjustment state of the screen device illustrated in FIG. 9.

### DETAILED DESCRIPTION OF THE EXEMPLARY EMBODIMENTS

Hereinafter, preferred embodiments are described in detail with reference to the accompanying drawings. The exemplary embodiments disclosed hereinafter are exemplary for understanding the present disclosure, and it should be understood that the exemplary embodiments can be implemented in diverse forms which are different from the exemplary embodiments disclosed hereinafter. However, in explaining the exemplary embodiments, detailed description and concrete illustration of well-known functions or constituent elements are omitted since they would obscure the present disclosure with unnecessary detail. In the drawings, sizes of some constituent elements may be exaggerated for clarity of explanation.

With reference to the accompanying drawings, a projection apparatus according to the exemplary embodiments will be described in detail.

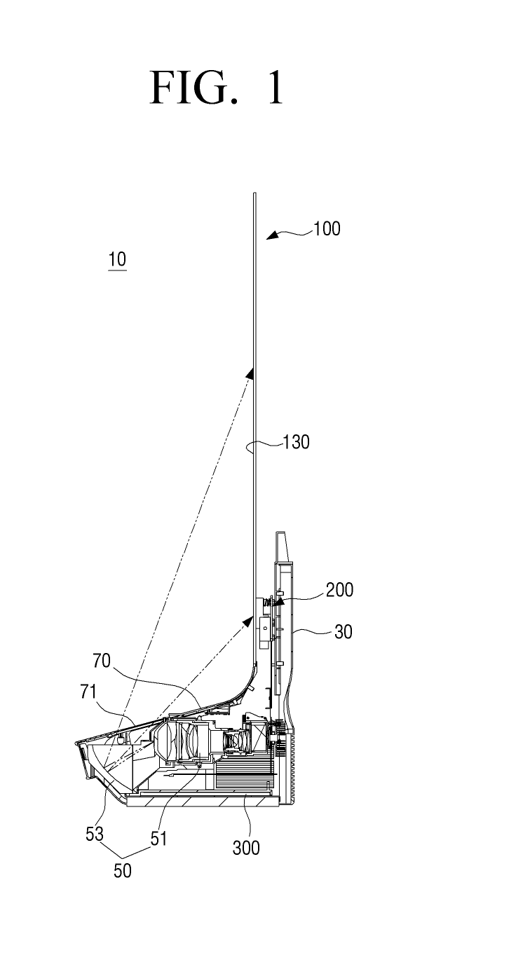

FIG. 1 is a schematic cross-sectional view which illustrates a projection apparatus according to an exemplary embodiment.

Referring to FIG. 1, a projection apparatus 10 according to an exemplary embodiment includes a housing 30, an image projector 50, a cover frame 70, a screen device 100 a screen 130, a supporting device 200, and a base frame 300.

The housing 30 includes a bottom portion 31 seated on a ground surface and a vertical portion 33 formed to extend upward from the bottom portion 31. The base frame 300 is fixedly installed on the bottom portion 31, and the vertical portion 33 covers the rear of the supporting unit 200. In this case, it is preferable to provide a hole that can expose a part of the supporting unit 200. That is, a predetermined region of the rear surface of the supporting device 200 on which first to third adjustment bolts or adjustment devices CB1, CB2, and CB3, to be described later, are installed. This is to conveniently operate the first to third adjustment bolts CB1, CB2, and CB3 through the hole of the vertical portion 33 without separating the base frame 300 from the housing 30.

The image projector 50 is fixedly installed on the base frame 300 to project an image onto a screen 130 of the screen device 100. The image projector 50, as described above, includes an optical system, which may include an illumination device (not illustrated), an image forming device (not illustrated), projection lenses 51, and an aspherical minor 53.

The illumination device generates light to be used to provide an image shape. The illumination device is provided with a red (R) LED, a blue (B) LED, and a green (G) LED which respectively generate red light, blue light, and green light as light sources.

As described above, in this exemplary embodiment, the illumination device is provided with three LEDs as the light sources. However, in other alternative exemplary embodiments, the illumination device may be provided with other types of light sources, such as lamps which generate white light (for example, arc lamps or halogen lamps).

The image forming device is implemented as a Digital Micro-mirror Display (DMD) panel. The DMD panel includes a large number of micro-minors, and each of the micro-minors corresponds an image pixel. By on/off operations of the micro-minors according to image signals, an image is formed from the light generated by the illumination device. The image projector 50 includes at least one reflection minor (not illustrated) that reflects the white light generated by the illumination device toward the image forming device.

The projection lenses 51 enlarge and project the image generated by the illumination device toward the aspherical mirror 53. A large number of projection lenses (not illustrated) for enlarging the image are provided.

The aspherical minor 53 displays the image enlarged and projected by the projection lenses 150 on the screen 130 through an opening 71 provided on the cover frame 70. In this exemplary embodiment, the image projector 50 displays the image through the aspherical minor 51, and the distance between the image projector 50 and the screen 130 can be much closer than that in other cases.

The cover frame 70 covers the base frame 300, and forms a part of an external appearance of the projection apparatus 10 together with the base frame 300. On the cover frame 70, an opening 71 is formed to permit the image from the image projector 50 to be projected onto the screen 130 of the screen device 100.

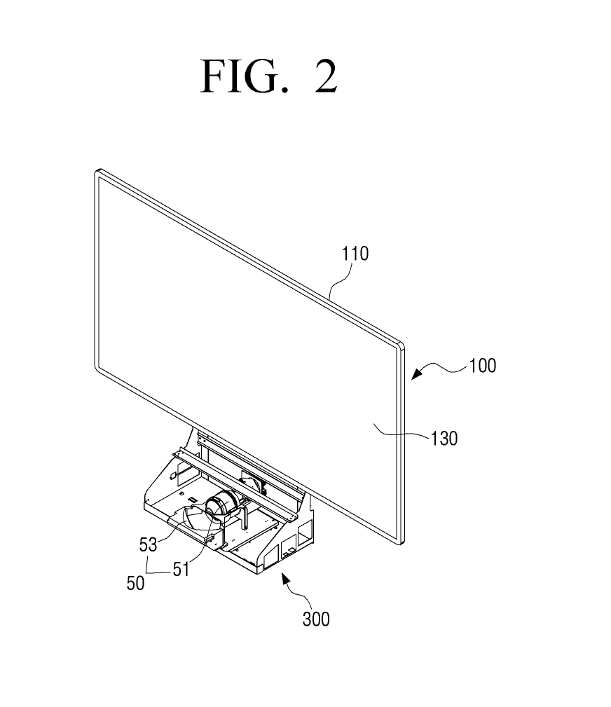

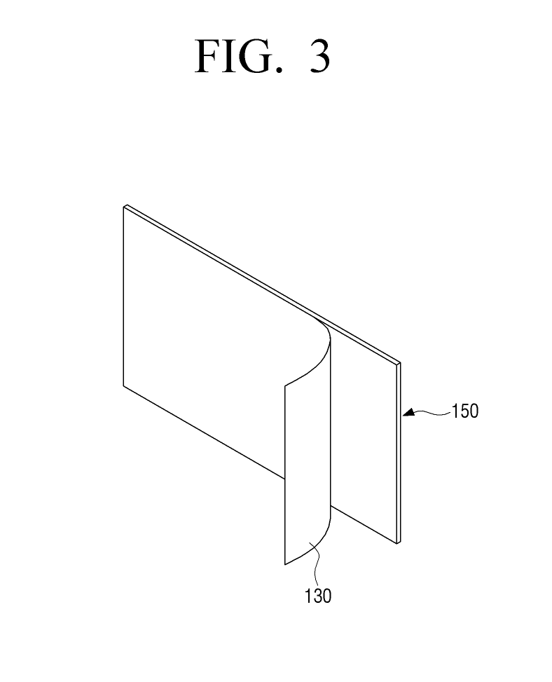

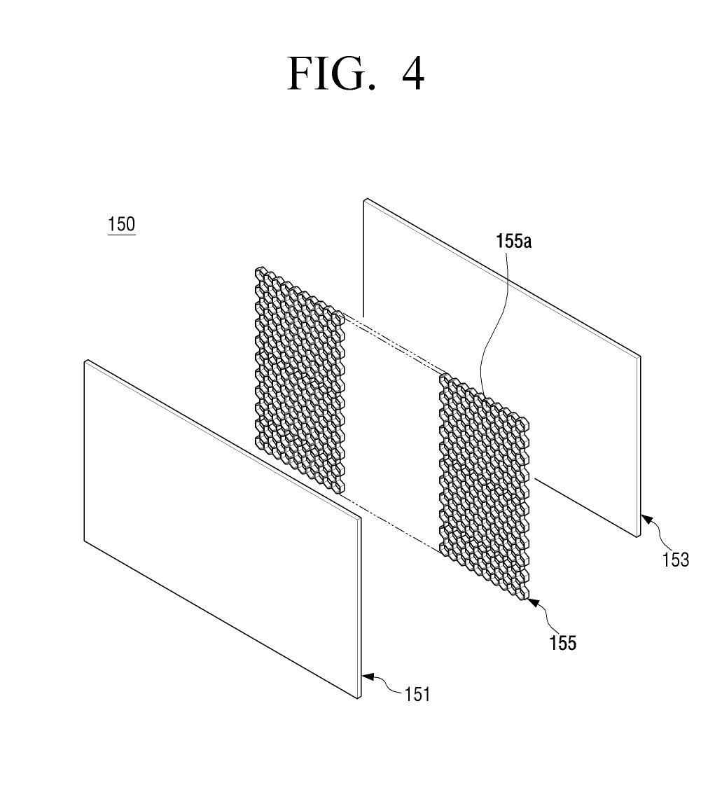

FIG. 2 is a perspective of the projection apparatus 10 with the housing 30 and the cover frame 70 omitted. FIG. 3 is a perspective view which illustrates the screen device 100 with the bezel 110 omitted. FIG. 4 is a schematic exploded perspective view which illustrates the support panel 150.

Referring to FIGS. 2 to 4, the screen device 100 includes a bezel 110, a screen 130, and support panel 150.

The bezel 110 surrounds outlines of the screen 130 and the support panel 150, and is fixedly installed on the support panel 150 through a plurality of fastening members (bolts or rivets) 111. In this case, since the screen 130 is supported by the support panel 150, the role of the bezel 110 as a frame for supporting the screen 130 can be omitted, and thus the bezel 110 can be produced with the minimum thickness and size. Accordingly, the overall size and weight of the screen device 100 can be minimized.

Referring to FIG. 3, since the screen 130 displays the image outside the projector, a user can view a desired image through the screen 130. The screen 130 may be formed of fiber glass or a PE (Polyethylene) film. Further, the surface of the screen 130 may be specially embossed to implement a 3D image.

The screen 130 as described above may be firmly attached to one flat surface of the support panel unit 150 through a laminating process, and thus the flatness of the screen 130 can be maintained. However, the adhesive method of the screen 130 is not limited to a laminating method, other adhesive methods, in which the screen 130 can be in contact with and be supported by one surface of the support panel 150, may be applied to the screen 130.

Accordingly, the screen device 100 according to an exemplary embodiment can basically solve various problems occurring in the related art technology that keeps the screen 130 flat by pulling four sides of the screen 130 using tension.

Referring to FIG. 4, the support panel 150 may include a first plate 151, a second plate 153, and a strength reinforcement member 155.

The first and second plates 151 and 153 are the same size and have predetermined thicknesses. The first and second plates 151 and 153 are coupled to the strength reinforcement member 155, and it is preferable that the first and second plates 151 and 153 are made of a metal material (metal alloy) which has a predetermined strength so as to maintain flatness. At this time, in order to minimize the weight, an aluminum alloy may be used as the metal material. However, the first and second plates 151 and 153 are not limited to metal material, but may be produced by nonmetal materials (for example, plastic resin) having a predetermined strength which is sufficient to maintain the flatness of the screen.

The strength reinforcement member 153 can favorably maintain the flatness of the support panel 150 by reinforcing the strength of the support panel 150 without increasing the thickness of the support panel 150. Accordingly, even if the size of the screen 130 is large, the flatness of the screen 130 attached to the support panel 150 can be favorably maintained through the strength reinforcement member 155.

As described above, the strength reinforcement member 155 is arranged between the first and second plates 151 and 153. In this case, the strength reinforcement member 155 is attached to the first and second plates 151 and 153 by adhesives; for example, by hot-melt adhesives.

Further, the strength reinforcement member 155 contains a plurality of cells 155a, and each of the cells 155a has a hexagonal prism shape. Accordingly, the strength reinforcement member 155, as a whole, has a honeycomb shape. However, the cell 155a of the strength reinforcement member 155 is not limited to the honeycomb shape, but may be modified in various shapes as would be understood by one of ordinary skill in the art. That is, each cell 155a may be changed to a rectangular prism shape, a cylindrical prism, or an elliptic cylinder shape but is not limited thereto.

Further, the strength reinforcement member 155 may be formed of an aluminum alloy having prominent strength, but is not limited thereto. The strength reinforcement member 155 may be formed of other metal materials or nonmetal materials (for example, plastic resin).

In addition to the strength reinforcement member 155, a front plate 151 and a rear plate 153 that constitute a screen attachment portion are formed of aluminum having prominent strength. Once the strength reinforcement member 155 having the honeycomb shape is fixedly attached between the first and second plates 151 and 153 of the support panel unit 150, the strength of the support panel 150 can be reinforced.

Accordingly, the deformation rate of the support panel 150 due to heat can be minimized, and thus the favorable flatness of the support panel 150 can be maintained. Accordingly, the deterioration of the quality of an image that is displayed on the screen that is bent due to the deformation of the support panel 150 can be prevented in advance.

Further, since the thickness of the support panel unit 150 can be reduced by the strength reinforcement member 155 having the honeycomb shape, the bezel 110 of the screen device 100 can be manufactured as a thin structure, and thus the overall weight of the screen device 100 can be reduced.

The projection apparatus 10 according to this exemplary embodiment can be implemented to be lightweight and slim through the thin and lightweight bezel of the screen device 100.

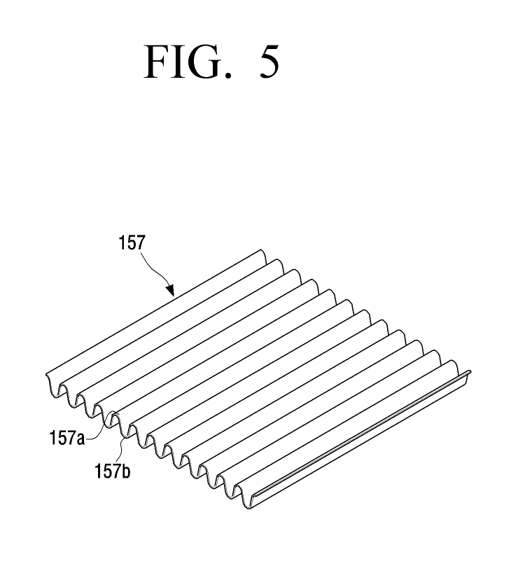

FIG. 5 is a perspective view which illustrates another example of a strength reinforcement member 155 having a honeycomb shape.

Referring to FIG. 5, the strength reinforcement member 157 may be implemented in a wave shape. Specifically, the strength reinforcement member 157 has a structure in which convex portions and concave portions 157a and 157b are alternately repeated. Here, the convex portions 157a and the concave portions 157b extend along the width direction or along the length direction of the strength reinforcement member 157. That is, one concave portion 157b is arranged between the two convex portions 157a, and one convex portion 157a is arranged between two concave portions 157b.

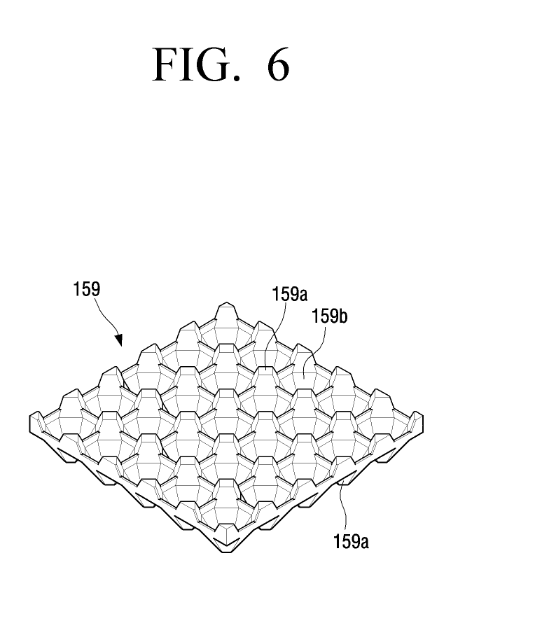

FIG. 6 is a perspective view which illustrates another example of the strength reinforcement member 155 having a honeycomb shape.

Referring to FIG. 6, the strength reinforcement member 159 may be formed in a predetermined egg plate shape in which a plurality of grooves are successively formed in upper, lower, right, and left directions at predetermined distances. Specifically, the strength reinforcement member 159 may include a plurality of convex portions 159a and a plurality of concave portions 159b, which are regularly repeated. One concave portion 159b is arranged between four convex portions 159a, and one convex portion 159a may be arranged between four convex portions 159a.

In this exemplary embodiment as described above, only three strength reinforcement members 155, 157, and 159 having different shapes are introduced. However, it is also possible to apply other strength reinforcement members having different shapes if they can contribute to the strength improvement and light-weight of the screen device 100.

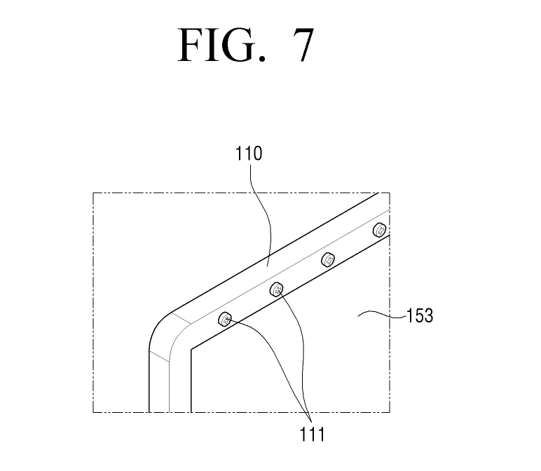

Referring to FIG. 7, this figure illustrates a partially enlarged perspective view which illustrates a rear surface of the screen device illustrated in FIG. 1. Shown in FIG. 7 is bezel 10, second plate 153 and bolts or rivets 111.

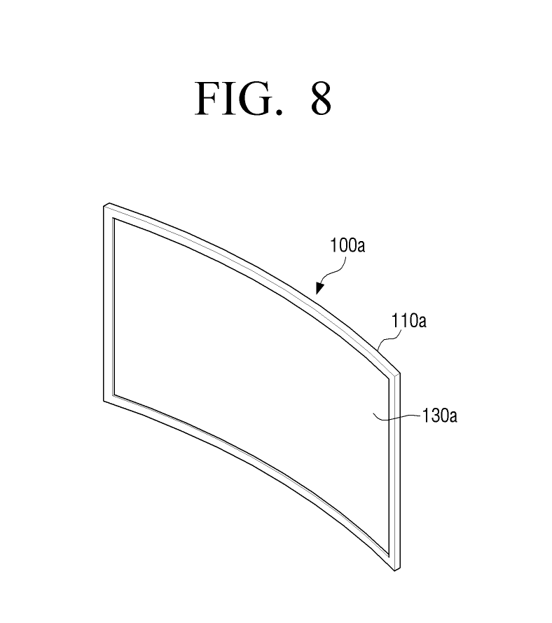

FIG. 8 is a perspective view which illustrates an example of a curved screen device 100.

As described above, the screen device 100 may be configured in a flat surface shape as described above, or may be configured in a curved shape as illustrated in FIG. 8. If the screen device 100a is in a curve shape as illustrated in FIG. 8, a user can be increasingly absorbed in the image (in particular, 3D image) during viewing of the image. As described above, the curved screen device 100a may be concavely formed in the right and left directions, and may be in a curved shape in the upper and lower directions. Further, although not illustrated, the screen device may be in a curved shape in upper, lower, right, and left directions. In this case, the surface of the screen appears to be curved, and the user can be increasingly absorbed in the image.

On the other hand, although not illustrated in the drawing, it is also possible to form an extra-large screen device 100 by successively connecting several sheets of support panels 150 and coupling the single screen 130 to the plurality of support panels 150. In this case, it is also possible to use a plurality of screens 130 which correspond to the respective support panel 150 without producing a single screen.

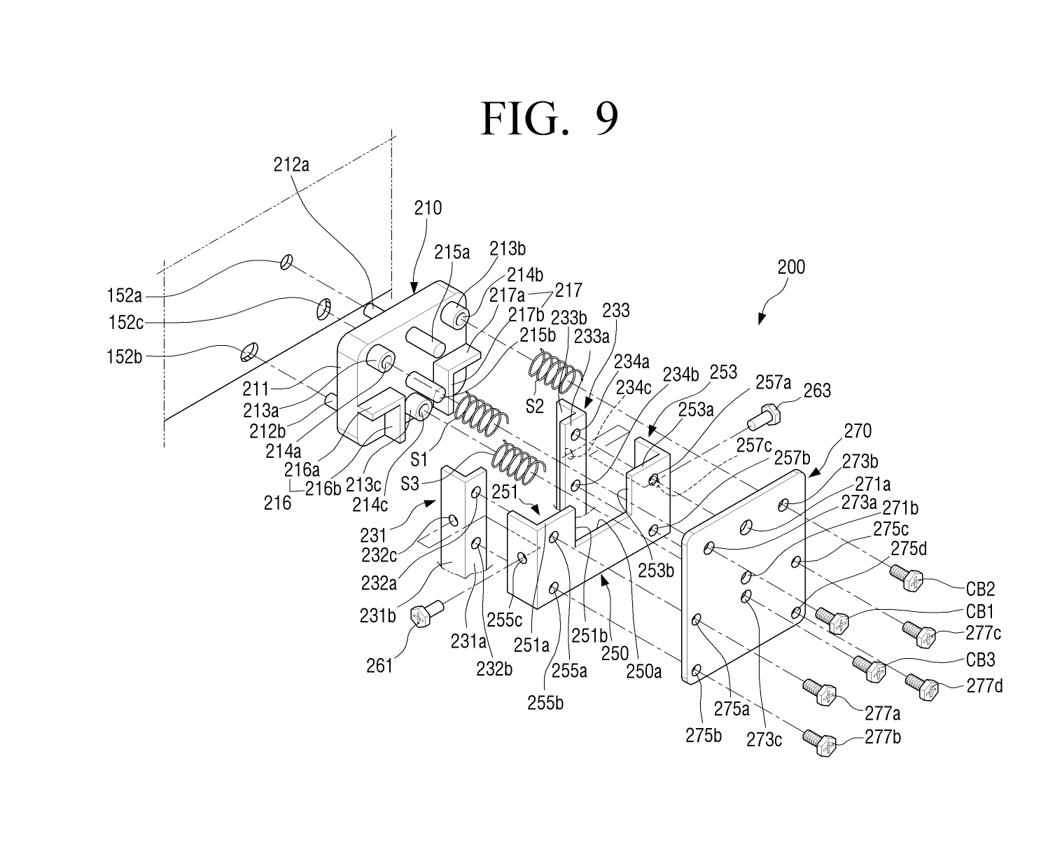

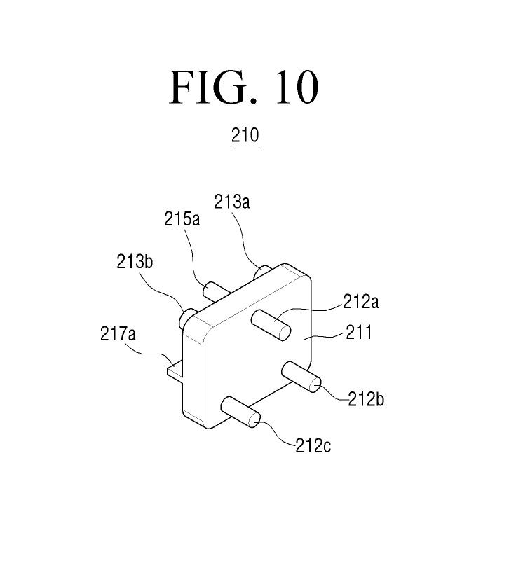

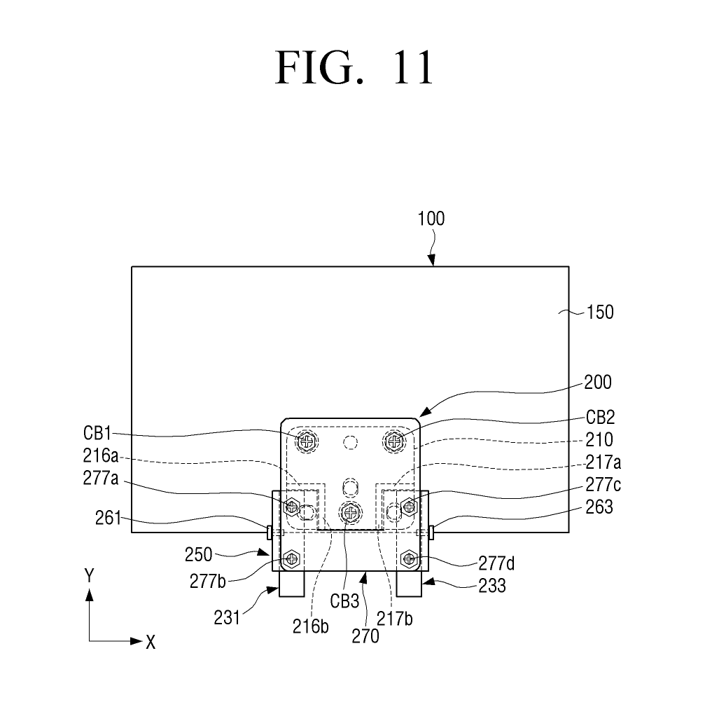

FIG. 9 is an exploded perspective view which illustrates the supporting device 200 of the projection apparatus 10 according to an exemplary embodiment. FIG. 10 is a perspective view which illustrates a front surface of a screen holder 210, and FIG. 11 is a schematic view which illustrates the supporting device 200 that is mounted on the rear surface of the screen device 100.

Referring to FIG. 9, the supporting device 200 is for adjusting the keystone phenomenon of the screen device 100, and can adjust the movement of the screen device 100 while supporting the screen device 100 in a standing state.

The supporting device 200 may include a screen holder 210, a first main bracket 231, a second main bracket 233, a guide bracket 250, and a coupling plate 270.

The screen holder 210 is coupled to the second plate 153 that forms the rear surface of the support panel 150. In this case, the screen holder 210 may be attached to the second plate 153 through adhesives (not illustrated) or an adhesive member such as two-sided adhesive tape (not illustrated), but is not limited thereto.

The screen holder 210 may include a body portion 211, first to third front guide protrusions 212a, 212b, and 212c, first to third fastening protrusions 213a, 213b, and 213c, first and second rear guide protrusions 215a and 215b, and first and second guide portions 216 and 217.

The body portion 211 has a predetermined thickness, and on the front surface thereof, the first to third front guide protrusions 212a, 212b, and 212c are formed. On the rear surface thereof, the first to third fastening protrusions 213a, 213b, and 213c, the first and second rear guide projections 215a and 215b, and the first and second guide portions 216 and 217 are formed.

The first to third front guide protrusions 212a, 212b, and 212c are inserted into the first to third guide holes 152a, 152b, 153 formed on the second plate 153 of the support panel unit 150. In this case, the first to third guide holes 152a, 152b, and 152c are formed substantially in a triangle shape, and the first to third front guide protrusions 212a, 212b, and 212c are inserted into the first to third guide holes 152a, 152b, and 162c, and thus the screen holder 210 can be arranged in a predetermine installation position on the second plate 153. In this case, in consideration of a coupling tolerance, as shown in FIG. 9, it is preferable that the second and third front guide holes 152b and 152c are elongated holes arranged in the horizontal and vertical directions.

The first to third fastening protrusions 213a, 213b, and 213c become three points for solving the keystones generated in the right and left directions and the upper and lower directions of the screen device 100.

The first to third fastening protrusions 213a, 213b, and 213c are arranged in positions that correspond to vertices of an inverted isosceles triangle on the rear surface of the body portion 211. That is, the first and second fastening protrusions 213a and 213b are arranged at the same height, and the third fastening protrusion 213c is arranged in a position which is the same distance between the first and second protrusions 213a and 213b and is lower than the first and second fastening protrusions 213a and 213b.

Further, the first to third fastening protrusions 213a, 213b, and 213c are coupled to first to third coil springs S1, S2, and S3, and the first to third coil springs S2, S2, and S3 elastically support the coupling plate 270 which is coupled to the rear of the screen holder 210 by first to third adjustment bolts CB1, CB2, and CB3.

In this case, the first to third adjustment bolts CB1, CB2, and CB3 are inserted into first to third through-holes 273a, 273b, and 273c of the coupling plate 270, and then screw-engaged with fastening holes 214a, 214b, and 214c of the first to third fastening protrusions 213a, 213b, and 213c. Accordingly, the first to third adjustment bolts CB1, CB2, and CB3 are rotated clockwise or counterclockwise to adjust the distance between the screen holder 210 and the coupling plate 270.

The first and second rear guide protrusions 215a and 215b are slidably inserted into the fourth and fifth through-holes 271a and 271b of the coupling plate 270 to guide the coupling between the screen holder 210 and the coupling plate 270. The first and second rear guide protrusions 215a and 215b are inserted into the fourth and fifth through-holes 271a and 271b before they are fastened to the fastening holes 214a, 214b, and 214c of the first to third fastening protrusions 213a, 213b, and 213c.

As described above, the first and second rear guide protrusions 215a and 215b guide the screen holder 210 when the screen holder 210 is separate from the coupling plate 270 or moves in the adjacent direction during adjustment of the first to third adjustment bolts CB1, CB2, and CB3.

The first and second guide protrusions 216 and 217 are formed to project symmetrically from the rear of the body portion 211 of the screen holder 210. The first and second guide protrusions 216 and 217 are provided with first and second straight line portions 216a and 217a positioned on the same straight line. Further, the first and second guide protrusions 216 and 217 are provided with third and fourth straight line portions 216b and 217b which are formed to extend downward from the first and second straight line portions 216a and 217a in a direction that is orthogonal to the first and second straight line portions 216a and 217a.

The first and second guide protrusions 216 and 217 are guided by the guide bracket 250 to be described later, and thus the right-left height and the right-left center of the screen device 100 are guided.

The first and second main brackets 231 and 233 may be formed to extend upward from the base frame 300 in a body with the base frame 300. Further, it is also possible that the first and second main brackets 231 and 233 are formed of a member that is separate from the base frame 300 and are fixedly coupled to the base frame 300 by a typical fastening members (not illustrated) or by welding.

The first and second main brackets 231 and 233 are coupled to the guide bracket 250 and the coupling plate 270 by a plurality of fastening bolts 277a, 277b, 277c, and 277d. Accordingly, the guide bracket 250 and the coupling plate 270 are fixed together with the first and second main brackets 231 and 233, and the screen holder 210 and the screen device 100 may move at a predetermined angle in front and in the rear based on the X-axis and the Y-axis.

The guide bracket 250 is provided with a first guide 251 and a second guide 253 symmetrically formed based on a center groove 250a. In this case, the groove 250a is formed so that it does not interfere with the second rear guide protrusions 251a and 251b and the third fastening protrusion 213c.

The first guide 251 has a first guide surface 251a and a second guide surface 251b arranged at right angles to the first guide surface 251a, and the second guide 253 has a third guide surface 253a positioned on the same straight line and a fourth guide surface 253b arranged at right angles to the third guide surface 253a.

In this case, the first and second guide protrusions 216 and 217 of the screen holder 210 are guided on the first and second guides 251 and 253. That is, the first and third straight line portions 216a and 217a of the first and second guide protrusions 216 and 217 are guided in a state where they are seated on the first and third guide surfaces 251a and 253a of the first and second guide portions 251 and 253, and thus the right and left heights of the screen device 100 can be constantly maintained.

Further, the second and fourth straight line portions 216b and 217b of the first and second guide protrusions 216 and 217 are guided in a state where they are in contact with the second and fourth guide surfaces 251b and 253b of the first and second guide portions 251 and 253, and thus the right and left center of the screen device 100 can be constantly maintained.

The coupling plate 270 is fastened to the first and second main brackets 231 and 233 and the guide bracket 250, which are kept in a fixed state, and is elastically fastened to the screen holder 210 that is maintained in a movable state.

FIG. 10 is a perspective view of a screen holder 210 of FIG. 9. FIG. 10 shows first to third fastening protrusions 213a-213c. The opposite side of screen holder 210 shows body 211 as well as first to third front guide protrusions 212a-212c.

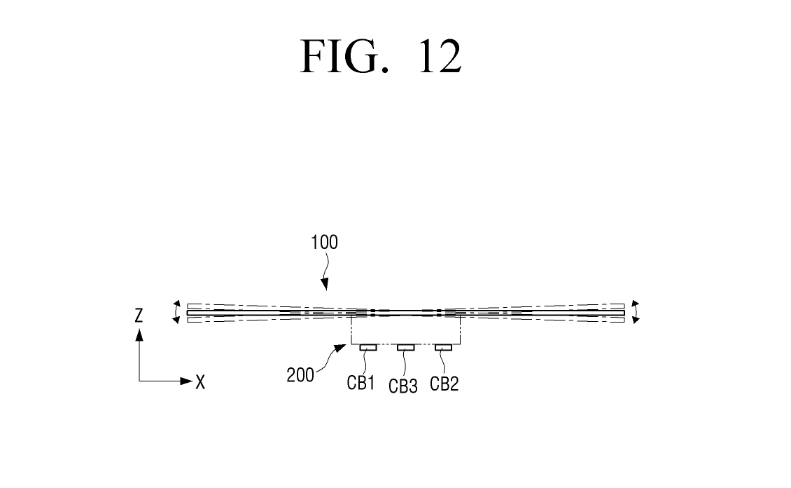

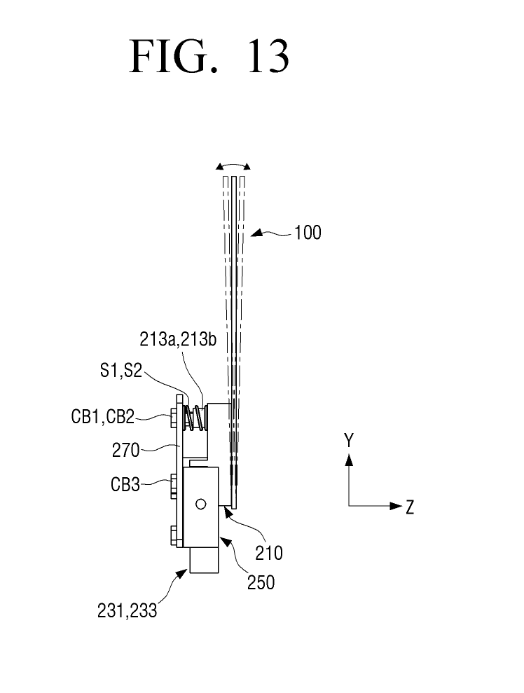

FIG. 11 is a schematic view illustrating the supporting device 200 that is mounted on the rear surface of the screen device 100. FIG. 12 is a schematic view which illustrates a right-left keystone adjustment state of the screen device 100, and FIG. 13 is a schematic view which illustrates a upper-lower keystone adjustment state of the screen device 100.

The supporting device 200 is arranged on the rear surface (specifically, on the lower side of the rear surface of the support panel 150) of the screen device 100 as shown in FIG. 11, and through the following processes, the supporting device 200 can solve the keystone phenomenon occurring on the screen 130 of the screen device 100.

Referring to FIGS. 11 and 12, in the case of adjusting the right-left keystone occurring on the screen device 100, the first and/or second adjustment bolts CB1 and CB2 are rotated at a predetermined angle clockwise or counterclockwise based on the third adjustment bolt CB3, and as shown in FIG. 12, the slope of the screen device 100 can be accurately adjusted about the Y-axis.

Further, referring to FIGS. 11 and 13, in the case of adjusting the upper-lower keystone occurring on the screen device 100, the third adjustment bolt CB3 is rotated at the predetermined angle clockwise or counterclockwise based on the first and second adjustment bolts CB1 and CB2. As shown in FIG. 13, the slope of the screen device 100 can be accurately adjusted about the Z-axis.

In addition, in the case where the image displayed on the screen 130 is not focused which produces a blurry image, the screen device 100 is moved forward and backward by rotating the first to third adjustment bolts CB1, CB2, and CB3 clockwise or counterclockwise, and thus the focus can be accurately adjusted.

Accordingly, in this embodiment, by adjusting the slope of the screen device or moving the screen device forward and backward through the operation of the first to third adjustment bolts CB1, CB2, and CB3, the keystone that appears when the image projected from the image projector 50 conflicts with the position or direction of the screen 130 and the focus can be precisely adjusted.

While the present disclosure has been shown and described with reference to certain embodiments thereof, it will be understood by those skilled in the art that various changes in form and detail may be made therein without departing from the spirit and scope of the present disclosure, as defined by the appended claims.

What is claimed is:

1. A screen device comprising:
a screen on which an image is projected; and
a support panel which includes a pair of plates and a strength reinforcement member arranged between the pair of plates,
wherein the screen is attached to any one of the pair of plates.

2. The screen device as claimed in claim 1, wherein the screen is laminated onto any one of the pair of plates.

3. The screen device as claimed in claim 1, wherein the reinforcement member has any one of a honeycomb structure, a wave shape, and a structure in which a plurality of grooves are successively formed at predetermined distances in upper, lower, right, and left directions.

4. The screen device as claimed in claim 1, wherein a side of the support panel, to which the screen is attached, is concavely formed.

5. The screen device as claimed in claim 1, wherein the screen device further comprises a plurality of support panels,
wherein all of the support panels are successively connected to one another, and the screen is attached to one surface of all of the support panels.

6. A projection apparatus comprising:
a screen device having a screen and a support panel to which the screen is coupled;
a supporting device which supports the screen device; and
an image projector which projects an image onto the screen.

7. The projection apparatus as claimed in claim 6, wherein the support panel comprises:
a pair of plates; and
a strength reinforcement member arranged between the pair of plates,
wherein the screen is attached to any one of the pair of plates.

8. The projection apparatus as claimed in claim 7, wherein the screen is laminated onto any one of the pair of plates.

9. The projection apparatus as claimed in claim 7, wherein the reinforcement member has any one of a honeycomb structure, a wave shape, and a structure in which a plurality of grooves are successively formed at predetermined distances in upper, lower, right, and left directions.

10. The projection apparatus as claimed in claim 6, wherein a side of the support panel, to which the screen is attached, is concavely formed.

11. The projection apparatus as claimed in claim 6, wherein the supporting device is connected to the screen device so that the supporting device supports the screen device and adjusts a slope of the screen device.

12. The projection apparatus as claimed in claim 11, wherein the supporting device comprises:
a screen holder coupled to the support panel of the screen device;
a coupling plate elastically connected to the screen holder so that the screen holder is movable;
a guide bracket coupled to the coupling plate to support the screen holder and to guide a right-left height and a right-left center of the screen device; and
a main bracket fixed to a base frame on which the supporting device is supported and connected to the guide bracket and the coupling plate.

13. The projection apparatus as claimed in claim 12, wherein the screen holder and the support panel are fixedly coupled to each other through an adhesive or through a fastening member.

14. The projection apparatus as claimed in claim 12, wherein a plurality of elastic members are arranged between the screen holder and the coupling plate.

15. The projection apparatus as claimed in claim 14, wherein the plurality of elastic members are supported by first to third fastening protrusions which project from the screen holder, and
the first and second fastening protrusions are arranged at a predetermined distance at the same height, and the third fastening protrusion is arranged at a height that is different from the height of the first and second fastening protrusions.

16. The projection apparatus as claimed in claim 15, wherein the third fastening protrusion is arranged in a position which is lower than the first and second fastening protrusions and is located the same distance from the first and second fastening protrusions.

17. The projection apparatus as claimed in claim 15, wherein the first to third fastening protrusions are screw-engaged with first to third adjustment devices which penetrate the coupling plate, and
the first to third adjustment devices adjust a distance between the coupling plate and the screen holder.

18. The projection apparatus as claimed in claim 12, wherein the screen holder and the coupling plate are elastically supported at first to third points, and
the first and second points are positioned at the same height by a predetermined distance, and the third point is arranged in a position which is lower than the first and second points and is located at the same distance from the first and second points.

19. The projection apparatus as claimed in claim 18, wherein first to third adjustment devices, which fasten the screen holder and the coupling plate to each other, are positioned at the first to third points, and
the first to third adjustment devices adjust a distance between the coupling plate and the screen holder in accordance with a degree of fastening between the screen holder and the coupling plate.

20. The projection apparatus as claimed in claim 12, wherein the guide bracket is provided with a first guide and a second guide which are symmetrically formed with each other,
the screen holder has a first guide protrusion and a second guide protrusion formed on a rear surface thereof to be guided by the first guide and the second guide, and
the first guide has a first guide surface and has a second guide surface which is arranged at right angles to the first guide surface, and the second guide has a third guide surface that is positioned along a same straight line as the first guide surface and a fourth guide surface arranged at right angles to the third guide surface, and
the first guide protrusion is guided on the first guide surface and the second guide surface of the first guide, and the second guide protrusion is guided on the third guide surface and the fourth guide surface of the second guide.
